(19) United States
(12) Patent Application Publication
(10) Pub. No.: US 2005/0055382 A1
(43) Pub. Date: Mar. 10, 2005

(54) Universal synchronization

(76) Inventors: Lounas Ferrat, San Francisco, CA (US); Jeffrey D. Richey, Austin, TX (US); Muralidharan Rangan, Sunnyvale, CA (US)

Correspondence Address: VIERRA MAGEN MARCUS HARMON & DENIRO LLP, 685 MARKET STREET, SUITE 540, SAN FRANCISCO, CA, 94105, US

(21) Appl. No.: 09/885,980

(22) Filed: Jun. 21, 2001

Related U.S. Application Data
(60) Provisional application No. 60/214,863, filed on Jun. 28, 2000.

(51) Int. Cl. G06F 17/30

(52) U.S. Cl. 707/201; 707/10

(57) ABSTRACT

A technology for bi-directional synchronization between at least two entities. Examples of entities include databases, operating system files, applications, email, etc. The two entities can communicate using any appropriate protocol and the two entities can be provided by different vendors using different designs. The synchronization technology includes an Application Programming Interface that enables developers to provide synchronization functionality as an integral part of their distributed applications. Additionally, conflict resolution during synchronization can be customized to suit the particular application. The synchronization technology allows for the management of data anywhere and enables developers to distribute application data and code across multiple tiered environments to applications and users located anywhere.

This application claims the benefit of U.S. Provisional Application No. 60/214,863, Universal Synchronization, filed Jun. 28, 2000, incorporated herein by reference.

### COPYRIGHT NOTICE

A portion of the disclosure of this patent document contains material which is subject to copyright protection. The copyright owner has no objection to the reproduction by anyone of the patent document or the patent disclosure as it appears in the United States Patent and Trademark Office patent file or records, but otherwise reserves all copyright rights whatsoever.

### Computer Program Listing Appendix

This patent document was filed with a Computer Program Listing Appendix stored on one compact disc. The Computer Program Listing Appendix includes the files listed in the table below. Each of the files listed below that are in the Computer Program Listing Appendix are incorporated herein be reference.

| | | |
|---|---|---|
| CatalogConstantCreates | 7 | KB 5/14/2001 |
| Class com_pointbase_unisync_repl_replEngine | 4 | KB 5/14/2001 |
| Class com_pointbase_unisync_repl_replServerEngine | 2 | KB 5/14/2001 |
| Class com_pointbase_unisync_rowset_rowsetAlterPublication | 2 | KB 5/14/2001 |
| Class com_pointbase_unisync_rowset_rowsetAlterPublicationAddD | 4 | KB 5/14/2001 |
| Class com_pointbase_unisync_rowset_rowsetAlterPublicationAdd(1) | 4 | KB 5/14/2001 |
| Class com_pointbase_unisync_rowset_rowsetAlterPublicationRemo | 4 | KB 5/14/2001 |
| Class com_pointbase_unisync_rowset_rowsetAlterPublicationR (1) | 4 | KB 5/14/2001 |
| Class com_pointbase_unisync_rowset_rowsetAlterSubscription | 3 | KB 5/14/2001 |
| Class com_pointbase_unisync_rowset_rowsetAlterSubscriptionAdd | 4 | KB 5/14/2001 |
| Class com_pointbase_unisync_rowset_rowsetAlterSubscription(1) | 4 | KB 5/14/2001 |
| Class com_pointbase_unisync_rowset_rowsetAlterSubscriptionRem | 4 | KB 5/14/2001 |
| Class com_pointbase_unisync_rowset_rowsetAlterSubscription(2) | 4 | KB 5/14/2001 |
| Class com_pointbase_unisync_rowset_rowsetBase | 1 | KB 5/14/2001 |
| Class com_pointbase_unisync_rowset_rowsetCommand | 8 | KB 5/14/2001 |
| Class com_pointbase_unisync_rowset_rowsetConflictingField | 7 | KB 5/14/2001 |
| Class com_pointbase_unisync_rowset_rowsetDataSource | 4 | KB 5/14/2001 |
| Class com_pointbase_unisync_rowset_rowsetEventLog | 6 | KB 5/14/2001 |
| Class com_pointbase_unisync_rowset_rowsetPublication | 7 | KB 5/14/2001 |
| Class com_pointbase_unisync_rowset_rowsetPublicationCreated | 2 | KB 5/14/2001 |
| Class com_pointbase_unisync_rowset_rowsetPublicationDataField | 6 | KB 5/14/2001 |
| Class com_pointbase_unisync_rowset_rowsetPublicationDataItem | 9 | KB 5/14/2001 |
| Class com_pointbase_unisync_rowset_rowsetSite | 7 | KB 5/14/2001 |
| Class com_pointbase_unisync_rowset_rowsetSiteProtocol | 5 | KB 5/14/2001 |
| Class com_pointbase_unisync_rowset_rowsetStatus | 7 | KB 5/14/2001 |
| Class com_pointbase_unisync_rowset_rowsetSubscription | 11 | KB 5/14/2001 |
| Class com_pointbase_unisync_rowset_rowsetSubscriptionDataField | 5 | KB 5/14/2001 |
| Class com_pointbase_unisync_rowset_rowsetSubscriptionDataItem | 10 | KB 5/14/2001 |
| Class com_pointbase_unisync_rowset_rowsetSyncEntity | 3 | KB 5/14/2001 |
| Class com_pointbase_unisync_rowset_rowsetUnresolvedConflict | 8 | KB 5/14/2001 |
| Interface com_pointbase_unisync_sync_syncCatalog | 11 | KB 5/14/2001 |
| Interface com_pointbase_unisync_sync_syncConflictContext | 2 | KB 5/14/2001 |
| Interface com_pointbase_unisync_sync_syncConflictResolver | 2 | KB 5/14/2001 |
| Interface com_pointbase_unisync_sync_syncEngine | 2 | KB 5/14/2001 |
| Class com_pointbase_unisync_sync_syncException | 3 | KB 5/14/2001 |
| Interface com_pointbase_unisync_sync_syncLogger | 2 | KB 5/14/2001 |
| Interface com_pointbase_unisync_sync_syncSession | 5 | KB 5/14/2001 |
| Class com_pointbase_unisync_util_utilPublication | 2 | KB 5/14/2001 |
| Class com_pointbase_unisync_util_utilPublicationDataItem | 2 | KB 5/14/2001 |
| Class com_pointbase_unisync_util_utilVerifier | 1 | KB 5/14/2001 |
| Package com_pointbase_unisync_repl | 1 | KB 5/14/2001 |
| Package com_pointbase_unisync_rowset | 1 | KB 5/14/2001 |
| Package com_pointbase_unisync_sync | 1 | KB 5/14/2001 |
| Package com_pointbase_unisync_util | 1 | KB 5/14/2001 |
| packages | 1 | KB 5/14/2001 |
| syncCommunicator | 5 | KB 5/14/2001 |
| syncReader | 8 | KB 5/14/2001 |
| syncWriter | 7 | KB 5/14/2001 |
| tree | 1 | KB 5/14/2001 |

### BACKGROUND OF THE INVENTION

1. Field of the Invention

The present invention is directed to technology for universal synchronization of data.

2. Description of the Related Art

As technology advances, the use of portable computing devices has increased. For example, many people use laptop computers and handheld computing devices for their every day job functions. These people tend to use these mobile computing devices away from the office; therefore, the mobile computing devices are loaded with software applications and databases that allow the employee to perform the relevant job tasks. Typically, a centralized database will be maintained at the office for storing corporate data. The mobile user's database and applications use the data from the central corporate database to perform the relevant functions. Thus, many mobile users will have copies of the central databases (or portions of the central databases) on their mobile computing devices.

While using their mobile computing devices, it is typical that a user will change the data on their mobile computing devices. Thus, the data on the mobile computing device will no longer match the data on the centralized database. Thus, there is a need to synchronize the data and/or other application information with a centralized database.

Various entities have provided applications for synchronizing data between a mobile computing device and a central location. However, these solutions are not complete and have many drawbacks. For example, these solutions tend to be vendor specific. That is, the synchronization technology works for one particular vendor's mobile computing technology and central computing technology. Additionally, the means for communication between the mobile computing device and the central computer tends to be limited to a docking cradle, a specific communication protocol and a specific means for communication (e.g. via conventional telephone lines). Existing solutions also are platform specific. That is, they tend to run on only certain computing platforms; therefore, requiring users to have a limited set of equipment that they can use for their job functions. Finally, existing synchronization technology is not customizable so that the user can program how to resolve conflicts and integrate the synchronization technology into other applications.

### SUMMARY OF THE INVENTION

The present invention, roughly described, provides for technology for universal synchronization (UniSync) of data. UniSync provides a cornerstone technology for managing data anywhere on the net. UniSync enables developers to distribute application data and code across multiple tiered environments to applications and users located anywhere. UniSync integrates with legacy data systems to extend corporate data to new applications and new users, to enable more efficient operations, better service, and new product and service opportunities.

UniSync uses a publish/subscribe model to enable data access and sharing between multiple disparate database systems. The publish/subscribe model supports the concept of a data “publisher” who maintains a master copy of the data. A “subscriber” in turn receives a copy of this data, with occasional updates to ensure that the publisher and subscriber data are consistent.

One embodiment of a database allows developers to incorporate an added level of security to their publish and subscribe applications, because they may assign a publish or subscribe privilege to any table in the database. Only tables with assigned privileges can synchronize data. This capability provides a developer with an additional level of assurance that secure or sensitive data will synchronize only under strictly managed conditions.

Within a database, publishers can synchronize an entire table of data, or a subset of the table (using any combination of rows and columns in that table). This capability ensures an efficient means to share data, because UniSync synchronizes only the data that a user needs. UniSync does not consume valuable network bandwidth and system resources to synchronize data that is redundant or irrelevant to a user's application. This feature becomes increasingly important with large data sets and large user populations.

UniSync also allows an additional level of refinement to the publish/subscribe model by supporting “users” and “roles.” This capability allows developers to control access to information that is either sensitive or restricted. In other words, a publication may be issued to a pre-defined set of “subscribers” who have the authority to access that information. In the mobile sales force example, managers in the regions may have additional access to information for their regions—information that is not available to the individual sales representatives (such as total sales projections for the region). UniSync provides a way to ensure that each set of users can access only the information that is relevant and appropriate to their roles.

UniSync supports a wide variety of network and data management topologies and provides the flexibility to address a range of synchronization requirements among multiple, disparate systems. UniSync allows data sharing in a one-way “broadcast” mode, as well as the ability to share data and updates back and forth between several different systems.

UniSync allows an application to monitor the synchronization connection and transactions through the entire process. If an unexpected interruption or conflict occurs during this process, UniSync notifies the application with the appropriate status and error code. The application can then handle this exception in a number of ways, including rolling back any uncommitted transactions or flagging the transaction for continued processing once the problem is resolved, such as reestablishing a broken connection.

Within the publish/subscribe model, databases can serve as a publisher, as a subscriber, or both. This capability is known as bi-directional synchronization. For example, sales representatives want to download the latest customer information from the corporate database, but they may also need to enter changes or additions to customer records based on new orders, changes of address, or new contact information. The sales representatives then need to synchronize these changes back up to the corporate database. In this case the application requires bi-directional synchronization. UniSync supports both unidirectional and bi-directional synchronization.

UniSync also allows developers to support data synchronization among large numbers of users, each of whom maintains a separate copy of the database. Examples include mobile clients, web appliances, and set top boxes. Any number of subscribers may connect to a publisher at any one time to obtain up to date information. UniSync manages the data connection and transmission through the entire synchronization session, assuring that the tasks are processed properly.

UniSync supports heterogeneous data synchronization between a PointBase database and major third party databases (including Oracle, IBM DB2, Sybase, and Microsoft SQL Server). Each of these systems can serve as a publisher, subscriber, or both for synchronizing data with a PointBase System.

UniSync incorporates a full set of functionality that allows developers to share data seamlessly between heterogeneous databases. The combination includes features to link disparate networks, systems, databases, and data formats. Plus, UniSync and Transformation Servers provide the ability to automatically resolve conflicts that may arise between synchronized data sets maintained across multiple systems.

UniSync manages database connections at both the publisher and subscriber sites. UniSync maps each database connection with a unique identifier that includes the system name, database name, schema, table, and user. When prompted by an application, UniSync will automatically create a session between any two systems on the network. UniSync also provides the ability to maintain multiple simultaneous connections between a large, distributed population of publishers and subscribers.

UniSync provides ubiquitous “data movement” across the network, between different platforms, and network architectures. UniSync provides a transparent link between a variety of systems and environments, which allows application developers to focus on the application logic for their distributed applications (and not on the complexity of communicating between disparate systems). UniSync will automatically synchronize data using a variety of network topologies and protocols including TCP/IP, HTTP and others. Developers do not need to write any additional application logic to support synchronization across these disparate environments.

With Transformation Servers, UniSync provides data transformation between systems that support differing data structures and formats. Different databases can each have unique ways of storing identical information. The Y2K problem provides a good example of how databases store identical data differently. Non Y2K-compliant systems use a two-digit year field (mm/dd/yy), while the compliant systems use a four-digit year field (mm/dd/yyyy). UniSync data transformation will automatically recognize and compensate for these disparities when synchronizing data across database systems. Other examples of UniSync data transformation functionality include support for ASCII/Unicode/EBCDIC, concatenation (automatically combining certain fields), and trimming (automatically shortening certain fields).

UniSync provides the necessary interfaces for resolving errors and conflicts between synchronized data. In many synchronization environments, discrepancies may arise when systems synchronize data after having been disconnected for some period of time. Typically, the system can synchronize most changes without issue. However, in some situations, the application will need to apply some level of business logic to synchronize the data successfully. UniSync provides the ability to identify and flag this discrepancy, with the outcome determined by the application's customizable business logic or by human intervention.

UniSync offers a comprehensive application programming interface (API) that enables developers to provide synchronization functionality as an integral part of their distributed applications. The UniSync API allows developers to deliver true transparent data and application synchronization, shielding the end users from the complexities of configuration and administration. For example, the application developer can integrate a “UniSync” menu command that allows a salesperson to obtain the latest price list and customer information with the click of the mouse. The salesperson does not have to know about the name, location, or schema of the remote database. All of this information is automatically configured as part of the application.

UniSync enables a number of synchronization modes tailored to specific application environments. For example, UniSync supports occasionally connected systems, small or large numbers of updates, as well as regular or on-demand synchronization. UniSync provides a flexible architecture to address a range of application characteristics based on: (1) the number of changes applied during a synchronization session, and (2) the periodicity of synchronization sessions.

The number of changes applied during a session will determine whether an application developer would like to apply a full copy or refresh or a delta update to the database. With a full copy refresh, all of the data in a subscriber table is deleted and replaced with a new copy from the publisher. By contrast, a delta update applies only the changes required to synchronize the current subscriber table with the publisher table. For instance, by adding or deleting a few rows or updating the data in a number of fields.

The periodicity of synchronization sessions can be regularly programmed, or they can occur on and ad-hoc basis. Regularly scheduled sessions typically require a dedicated network connection so that synchronization can occur unattended at set intervals. Programmed synchronization can occur instantaneously (on a second-by-second basis) or at set times (such as hourly, daily, or weekly). For environments that do not have a continuous, dedicated network connection, synchronization occurs on an ad hoc basis. In this case, an application will commonly initiate a synchronization session on demand, once the system has connected to the network.

A batch refresh provides applications with an efficient means to transmit large numbers of changes, additions, or deletions to one or more subscriber databases. As part of a batch refresh, UniSync automatically deletes the appropriate data from the subscriber database and replaces the data with a full copy of the table from the publisher database. A batch refresh may be scheduled to occur regularly, at any interval (from minutes to weeks). UniSync will automatically initiate the synchronization session. This synchronization typically assumes that both subscriber and publisher are continuously connected to the network. Data marts commonly use batch refresh to download data regularly from a host transaction system on a daily, weekly, or monthly basis.

Snapshots provide an excellent method to transmit large amounts of data to and from systems that are only occasionally connected to the network. When a subscriber or publisher connects to the network, an application directs UniSync to delete all of the data from the subscriber table and transmit a full copy of the updated table from the publisher. Snapshot mode is commonly used for transmitting moderate amounts of data to one or more subscribers on demand. For example, snapshots provide a means for sales representatives to download a new product catalog at any time from the corporate headquarters.

UniSync also provides the ability to synchronize individual updates on a regularly scheduled basis. These updates typically represent smaller numbers of changes. For instance, a branch office may prefer to update only changes to the employee roster, rather than have to retransmit the entire list of employees. This capability can save valuable network bandwidth and allow updates to occur much more quickly, especially for smaller amounts of changes. Since the updates occur automatically (and unattended), this synchronization mode will most commonly apply to systems with a dedicated network connection.

UniSync enables spontaneous updates for subscribers who connect to the Net for the most up to date information. UniSync transmits only the changes made to the subscriber table, which saves network bandwidth and reduces connection time. Updates can occur at any time and at any interval, depending on the nature of the application. A sales representative may need to synchronize customer orders on a daily basis, while a maintenance engineer may connect multiple times a day to diagnose a service problem and order a replacement part as quickly as possible.

The present invention can be accomplished using hardware, software, or a combination of both hardware and software. In one embodiment, the software used to implement the present invention is 100% Java. The software used for the present invention is stored on one or more processor readable storage media including hard disk drives, CD-ROMs, optical disks, floppy disks, RAM, ROM or other suitable storage devices. In alternative embodiments, some or all of the software can be replaced by dedicated hardware including custom integrated circuits, gate arrays, FPGAs, PLDs, and special purpose computers.

These and other objects and advantages of the present invention will appear more clearly from the following description in which the preferred embodiment of the invention has been set forth in conjunction with the drawings.

### BRIEF DESCRIPTION OF THE DRAWINGS

FIG. 1 depicts a common topology used for synchronization/replication. This topology includes a centralized database server called a hub which is single port of synchronization for mobile users called spokes.

FIG. 2 provides a block diagram of a architecture for the present invention.

FIG. 3 provides a block diagram of the architecture for the UniSync technology.

FIG. 4 provides a block diagram of the publisher and subscriber of the present invention.

FIG. 5 provides a block diagram of the scraper/reader architecture.

FIG. 6 is a block diagram of the components of a computer system that can be used to implement the present invention.

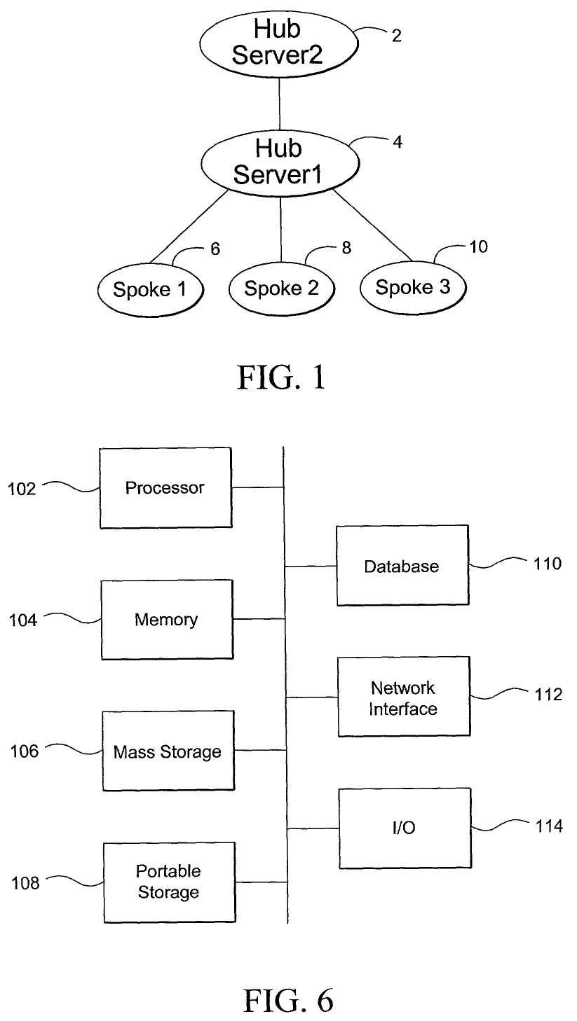

### DETAILED DESCRIPTION

1. Objectives & Scope

The PointBase UniSync engine requirements, architecture and high-level design will be described in this document. All the different reviews and comments of the present document will also be maintained in this document as a reference.

2. General Requirements

Easy to use, install and embed in a third party application
Easy to administer (as per our database requirement)
Ubiquitous
Seamless
Support hand-held devices
Small foot-print

2.1 Customer Requirements
Provide Java synchronization API for third party applications
Replicate Large Objects (Blobs & Clobs)
Conflict Resolution Mechanism
Provide Java and SQL filtering
Provide Java and SQL Transformation
Ability to do both “push” and “pull” from one single site
Ability to a spoke do synchronization inside a VPN (Virtual Private Network). In other words, UniSync should handle Spoke Dynamic IP address.

2.2 Design Requirements
One single synchronization engine (publisher & subscriber in one engine)
Use as much as possible the PointBase technology for filtering and transformation
Support multiple protocols such as TCP/IP, HTTP and RMI
Provide synchronization through fire-walls
Flexible architecture to support document based, file-based and eventually e-mail based data replication
Use of XML or HTML if needed as formatting protocols
Usage of Java factories to handle optional functionality such as Filtering, Transformation and Conflict Resolution.

Usage of JDBC 2.0 Cached Row Set to improve inter-operability with third party applications/engines
Able to “scrape” legacy DBMS and non-DBMS (such as data files)

2.3 Scalability Requirements
UniSync engine should support 100 to 1000 mobile databases
UniSync engine should be able to replicate large volumes of data with acceptable performance
Communication between engines should work through TCP/IP or RMI over HTTP protocols
   3. Functionality & Specifications

In this section we will describe the synchronization basic concepts and topologies.

3.1 Hub & Spoke Topology

The most common topology used in the synchronization/replication is a centralized database server called “hub” which is a single point of synchronization for mobile users called “spokes”.

The hub server 2 is the single point of synchronization for all the spokes 6, 8, 10. All the changes happening on the spokes are first pushed to the hub and then pulled back to the spoke. The spokes do not know each other, they all synchronize through the hub.

The UniSync engine will be able to do a push and a pull usually in this order. Both the push and the pull are optional. For example if a salesman goes on vacation for 2 weeks, when he comes back, his database may be obsolete. A lot of changes may have happened on the hub side during his absence. The only thing he might need is a “pull” to synchronize again with the hub. Most of the time the initiative to “sync” with the hub server is taken by the spoke.

Complex topologies such as “hierarchy” of hub servers and “multi-hubs and spokes” can also be handled by this proposal with a minimum of modifications.

We will be able to provide synchronization between 2 spokes however if the 2 spokes participate in a hub and spoke topology it is not advisable to replicate data between 2 spokes. They will synchronize through the hub.

Allowing spokes to synchronize with each other is not advisable for two reasons:
1) the conflict resolution mechanism needs to be implemented on the spoke databases where it is not needed.
2) It is potentially very difficult to keep track of which spoke has replicated data to which other spoke. We don't want updates to be replicated twice to the hub server.

However we should allow spoke users to replicate data between each other if they work/change on subset of data that are mutually exclusive.

3.2 Synchronization Commands

We can classify the UniSync commands in two types:

1. The command that deals with tables and views called “snapshot”. The snapshot command can copy one or many tables from one site to another site. Usually this command is used only once at the beginning of the process to synchronize the hub with the spoke.
2. The command that deals with “deltas” or change is called in UniSync “point Update”. The pointUpdate command replicates changes of one or many tables from one site to another site. The ContinuousUpdate command is just another variant of the previous, the difference is that it is repetitive based on a specified time-out.

3.3 Push and Pull Mechanism

One of the requirements that we would like to satisfy is the ability to do both “push” and “pull” in a single UniSync engine. For example, the ability to do a “push” for a spoke to move all the changes to the hub server and eventually resolve conflicts, and then do a “pull” to synchronize the hub server and the spoke database. These operations “push” and “pull” may be optional.

The “push” and “pull” can be applied for all the commands that are described previously. UniSync engine provides the 3 basic commands snapshot, pointUpdate and continuousUpdate. They can “push” or “pull” depending of the requirement.

These commands can be called directly from UniSync API. UniSync engine will support both “push” commands and “pull” commands at the same time. The user/application will decide to “push” or to “pull” and snapshot table for example depending on which site the command is executed. The outcome should be exactly the same for the UniSync engine.

3.4 Publish & Subscribe Functionality

UniSync engine has adopted the “publish” & “subscribe” model in version I, we will also adopt this mechanism in this version. We will provide the ability to publish objects (such as tables) in one database and the ability to subscribe to the published objects from another database. The site that publishes objects is called “publisher” and the one that subscribes to it is called “subscriber.”

A site can be optionally publisher and subscriber at the same time. For example, if a site is receiving only data changes coming from a hub then the site is subscriber only. A hub/spoke site can be publisher only, subscriber only or both.

3.5 Communication and Formatting Protocols

The plan is to support the common communication protocols:
1. TCP/IP
2. HTTPS
3. RMI

We will also support the following message formatting protocols:
4. XML protocol
5. HTML protocol
6. Serialized object protocol for row sets (initially result sets)

3.6 Unit of Replication

When synchronizing data between two databases, usually many tables belonging to a same application are moved from the publisher to the subscriber. Most of the synchronization tools consider a table as the unit of replication.

In UniSync we have grouped a set of tables in a container and then used the container as a unit of replication. The tables in a container are ordered depending of the relationship between tables. For example, the “parent” table is always replicated before the “child” table to avoid any constraint violation of the subscriber side.

To do that we need to adapt the current UniSync meta-data catalogs to handle multiple tables in a publication and subscription.

3.7 Replication Sub-Components

UniSync Engine is composed of multiple sub-components described below. It includes a Listener, an Executive processor, a Scraper, a Communicator, a Meta data manager, and a Logger. The following are the optional components: a Filter processor and a Transformer.

3.7.1 Publish & Subscribe: Table Mapping

The idea behind this concept is the ability for UniSync to replicate data from a publisher table to a subscriber table with different schemes and column types. In the UniSync Meta data catalog we maintain a table and column mappings used during replication/transformation.

3.7.2 Database Scraper

UniSync will make JDBC calls to the database to read either a list of table data for “snapshot” or a log for “continuous update” or “point update”. The scraper receives requests from the engine and starts to scrape the database depending of the request. The outcome is will a “set” of row sets that it passes then to the Filter thread.

One of the new features that we are providing here is the database log access through JDBC. There are two advantages (1) the homogenous access of the database and (2) the resolution of the synchronization issue when accessing the PointBase transaction log.

3.7.3 Data Filtering

Spoke databases do not need all the hub server information replicated back and forth. Only the selected objects (set of tables) will be replicated. For example, in a product information database, only information related to a specific region will be replicated for a salesman doing business in that region. Data filters are described in the UniSync Meta data tables to handle such a mechanism. You can also express Filtering through UniSync associated commands executed under JDBC (see section: Log Access Through JDBC).

3.7.4 Data Transformation

This is the ability of the UniSync engine to transform data before writing it to a subscriber database. For example, date column can be translated to another format before writing it to the database.

3.7.5 Communication

Two UniSync engines communicate through the “communication” layer, which is used to both sending and receiving data. The communication layer is used to “hide” the network protocol such as TCP/IP, HTTP or RMI and eventually SMTP if replication is happening through e-mail.

3.7.6 Event Logging

3.7.6.1 Functionality

The logging mechanism is an important facility provided in UniSync. It is essentially used to inform the user if the system has done its job and everything went all right or something went wrong. The list of the requirements is the following:

1. Ability to log information about the events flowing in the system

Agent operations started from the GUI
Thread start & stop will be logged
Target errors or information will be logged
Database connection or disconnection will be logged
   2. Ability to trace both the publisher engine and the subscriber engine
Messages flowing in the system such as scraper received “stop continuous update”
Messages and their transfer through the adopted protocol
   3. Ability to view selectively the log/trace information on the GUI when required. Examples:
View the last 20 operations executed by the publisher engine
View the status of the subscriber engine

3.7.6.2 Example of Log File
1999-09-24 17:35:04.187000000;UniSync Engine; Executive Server; can't find given IP address.
1999-09-27 15:33:56.718000000;UniSync Engine; Executive Server; could not listen on port: 2000.
1999-10-04 14:42:36.735000000;UniSync Engine; Executive Server; can't find mapping “TiMAP”.
1999-10-04 14:42:36.735000000;UniSync Engine; Scraper; table snapshot: EMPLOYEE started.
1999-10-04 14:42:36.735000000;UniSync Engine; Scraper; table snapshot: DEPARTMENT started.
1999-10-04 14:42:36.735000000;UniSync Engine; Scraper; table snapshot: COMPUTERS started.
1999-10-04 14:42:36.735000000;UniSync Engine; Scraper; table snapshot: OFFICES started.
1999-10-04 14:42:36.735000000;UniSync Engine; Scraper; table snapshot: PROJECTS started.
1999-10-04 14:42:36.735000000;UniSync Engine; Scraper; table snapshot: EMP_PROJ started.

3.7.7 Conflict Resolution

Conflicts occur when remote database changes violate system constraints. Disconnected users may allow database operations that cannot be replicated to the hub server.

UniSync solves conflicts at the hub server level. When the hub server accepts or rejects the changes coming from the spoke database, the change is then propagated back to the spoke database via the “pull” mechanism.

3.7.8 Propagation

The concept of propagation is inherent to data changes and network topology. Object changes need to flow between the sites that have “subscribed” for the changing objects.

Example1: if you have site1 and site 2, if you add row to site1 you propagate it to site2 and that's it.

Example2: If you have Hub, spoke1, and spoke2. If you add a row to spoke1, you propagate it first to Hub during a “push” to Hub from spoke1. Then you propagate the row from Hub to spoke2 and that's it.

To propagate data in a consistent way we need to classify the sites, identify clearly the relationships between sites and keep track of the changes. There are some other complicated propagation cases that are not described in this document but will be detailed in another document.

3.7.9 Security and Encryption

The first level of security used by UniSync is (1) the user authentication and (2) table publication/subscription privileges. PointBase database will provide grant operations on the tables for publication/subscription. The commands will be:
Grant publish on <table> to <user>.
Grant subscribe on <table> to <user>.

The second level of security is related to the transport mechanism. Since data that is replicated by UniSync may pass over a public network, data encryption may be needed between two UniSync engines. An encryption algorithm can be applied to data and then a decryption algorithm can be applied when data reaches the destination.

3.7.10 Rejected Transaction & Conflict Resolution

This concept is linked to disconnected users. On his spoke database a user can commit any transaction as soon as it does not violate local constraints. However, when the transaction is replicated back to the hub server there might be conflicts and the transaction is then rejected or “changed” (by the conflict resolution mechanism). In this case, we need to redo the transaction at the spoke database (the spoke who issued the transaction need to rollback the transaction for consistency reasons).

3.7.11 Recovery Mechanism

Working in a network and database environment puts a higher risk of “crashes” and/or failures. When UniSync is restarted, it should recover from the previous state. To do that we need to put in place a recovery mechanism for both snapshot and point update functionality.

The unit of recovery could be a table, set of rows or an transaction. The following table describes for each sync operation the recovery unit possible.

| Functionality | Table | Set of Rows | Transaction |
|---|---|---|---|
| Snapshot | Possible | Possible | N/A |
| Point Update | N/A (*) | Possible | Possible |

(*) Point Update cannot recover of a table basis because a transaction may be single table related or multiple tables related.

4. Decision & Methods

In this section we describe the basic concepts developed to support our architecture. Some of these concepts exist already and are implemented in the previous version of UniSync.

4.1 Basic Concepts

4.1.1 Row Set

4.1.1.1 Functionality

A Row Set is an extension of the JDBC 2.0 Result Set. It is basically a set of rows with some other specific properties. Row Sets make it easy to send tabular data over a network. In our case Row Set will be used to exchange data between two UniSync engines. We will be using mainly the cached Row Set object.

The row set mechanism will facilitate:
Filtering
Transformation
And Conflict Resolution.

4.1.1.2 Example of Row Set

© PointBase, Inc. 2000
// Creation
CachedRowSet Crset = new CachedRowSet( );
// Setting up general parameters
Crset.setType(ResultSet.TYPE_SCROLL_INSENSITIVE);
Crset.setConcurrency(ResultSet.CONCUR_UPDATABLE);
// Setting up SQL statement
Crset.setCommand(“SELECT * FROM EMPLOYEES”);
// Setting up Connection
Crset.setDatabase(“jdbc:pointbase:PUB_DB”);
Crset.setDriver(“com.pointbase.jdbc.jdbcDriver”);
Crset.setUserName(“public”);
Crset.setPassword(“public”);
Crset.setTransactionIsolation(Connection.TRANSACTION_READ_COMMIT
TED);
// Getting data
Crset.execute( );

4.1.2 Document:

A row set translated/formatted into XML or HTML. Example: an XML file that contains a set of rows.

4.1.3 Operation:

Synchronization request used to execute a specific synchronization operation. Example: Snapshot, Continuous Update, and Point Update

4.1.4 Interface:

UniSync API is a Java API used internally in UniSync and also published for customers. UniSync API can be used in a third party application and in our tools such as toolsConsole (Graphical User Interface to our database.)

4.1.4.1 Command API

© PointBase, Inc. 2000

public String getThisSite( ) throws syncapiException;

public void pointUpdate(String p_MappingName) syncapiException;

public void setThisSite(String p_SiteName) throws syncapiException;

public void snapshot(String p_MappingName) throws syncapiException;

public void startContinuousUpdate(String p_MappingName, int p_Period) throws

syncapiException;

public void startSyncService( ) throws syncapiException;

public void stopContinuousUpdate(String p_MappingName) throws syncapiException;

public void stopSyncService( ) throws syncapiException;

public void truncate(String p_MappingName) throws syncapiException;

4.1.4.2 Catalog API

public void addMapping(syncapiMapping p_Mapping) throws syncapiException;

public void addPublication(syncapiPublication p_Publication) throws syncapiException;

public void addSite(syncapiSite p_Site) throws syncapiException;

public void addSubscription(syncapiSubscription p_Subscription) throws syncapiException;

public Enumeration getAllMappings( ) throws syncapiException;

public Enumeration getAllPublications( ) throws syncapiException;

public Enumeration getAllSites( ) throws syncapiException;

public Enumeration getAllSubscriptions( ) throws syncapiException;

public syncapiMapping getMapping(String p_MappingName) throws syncapiException;

public syncapiPublication getPublication(String p_PublicationName) syncapiException;

public syncapiSite getSite(String p_SiteName) throws syncapiException;

public syncapiSubscription getSubscription(String p_SubscriptionName) throws

syncapiException;

public void removeAllCatalogInfo( ) throws syncapiException;

public void removeAllMappings( ) throws syncapiException;

public void removeAllPublications( ) throws syncapiException;

public void removeAllSites( ) throws syncapiException;

public void removeAllSubscriptions( ) throws syncapiException;

public void removeMapping(String p_MappingName) throws syncapiException;

public void removePublication(String p_PublicationName) throws syncapiException;

public void removeSite(String siteName) throws syncapiException;

public void removeSubscription(String p_SubscriptionName) throws syncapiException;

public void setPublication(syncapiPublication p_Publication) throws syncapiException;

public void setMapping(syncapiMapping p_Mapping) throws syncapiException;

public void setSite(syncapiSite p_Site) throws syncapiException;

public void setSubscription(syncapiSubscription p_Subscription) throws syncapiException;

4.1.4.3 Connection API

public void setConnection(Connection connection) throws syncapiException;

4.1.4.4 Publication API

public syncapiPublication(String p_Name) throws syncapiException;

public void setCommitBehavior(boolean p_CommitBehavior);

public boolean getCommitBehavior( );

4.1.4.5 Subscription API

public syncapiSubscription(String p_Name) throws syncapiException;

public int addColumn(String p_TableName, String p_ColumnName) throws syncapiException

public int addColumn(String p TableName, String p_ColumnName, String p_Transformation)

throws syncapiException;

public String[ ] getTransformations(String p_TableName) throws syncapiException;

public String getTransformation(String p_TableName, String p_ColumnName) throws

syncapiException;

4.1.5 Processor

A Processor is a Java thread with a specific functionality. The processor has a queue attached to it.

Examples: Logger. This is the same mechanism that is used in the previous PointBase Synchronization engine. This mechanism can be used by the logging mechanism.

4.1.6 Queuing Mechanism

Basic queue used to hold objects for the processor to consume. Example: queue of commands/requests to be executed by a processor. The processors use this mechanism to hold requests in queues before consumption.

4.1.7 Communicator

Abstract class used to handle basic communication between two machines through TCP/IP, HTTP and RMI. The communicator is used for sending and receiving data. It is used by UniSync engines to initiate communication or to exchange data.

4.2 General Architecture

4.2.1 Objectives
Scalability of UniSync
Availability of UniSync
Bi-directional replication
Push and Pull Anywhere
Selective Meta Data Distribution

4.2.2 Architecture

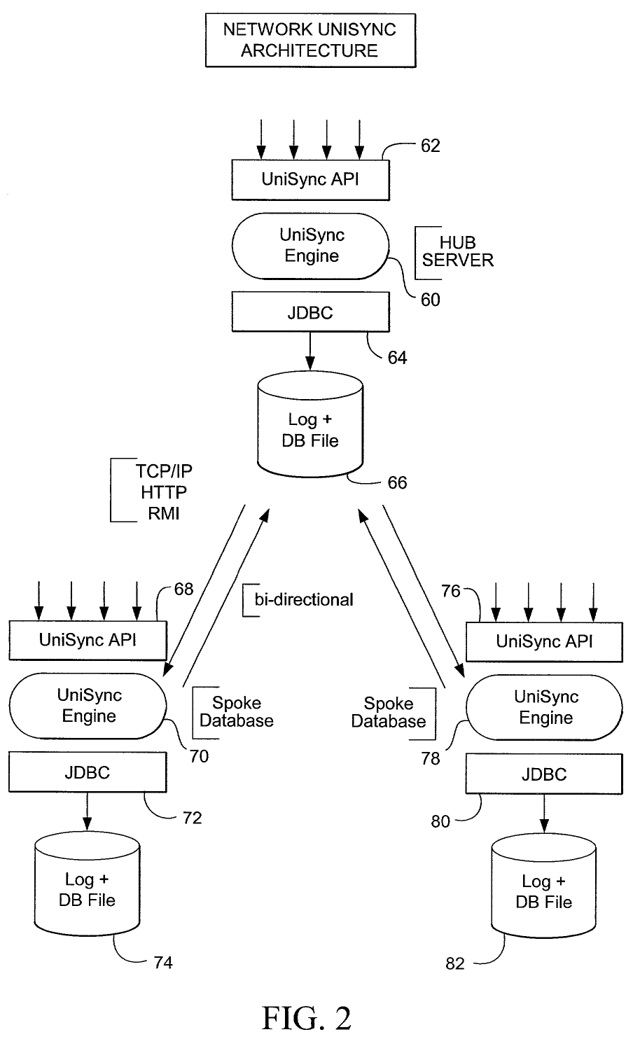

FIG. 2 provides a block diagram of the architecture

4.3 UniSync architecture

4.3.1 Objectives
Bi-directional in a single engine
Engine can send to 1-n engines
Engine can receive from 1-n engines
Communicator can send and receive
Optional: Filter, Transformer, and Conflict Manager
Programmatic UniSync API

4.3.2 UniSync Engine Design requirements

A session is a UniSync API call such as snapshot or point update.
1. There will be 1 replicator 18/session
2. Subscriber Engine takes 2 parameters: Transport protocol and Formatting protocol
3. There will be 1 scraper 40/session
4. There will be 1 db Writer 42/session
5. There will be 1 Catalog Manager UniSync engine (Catalog Manager will be attached to Executive)
6. There will be 1 Logger 46/UniSync Engine (Logger attached to Executive)

4.3.3 UniSync Replicator 18 Design requirements
1. Takes a central place in the UniSync Engine
2. Talks to all other sub-components such as Communicator 30, Scraper
3. Sends commands to Scraper (snapshot, point update) and passes syncPub object.
4. Gets all the info necessary from the catalog before invoking scraper
5. Will be the only one talking to Meta Data Manager 44
6. Will receive back row sets and add sync_rec_id to these rows before sending them to Comm.
7. Sends row sets to Communicator 30
8. Receives results/errors back from Communicator 30
9. Logs events/errors/etc via Event Logger 46

4.3.4 UniSync Diagram

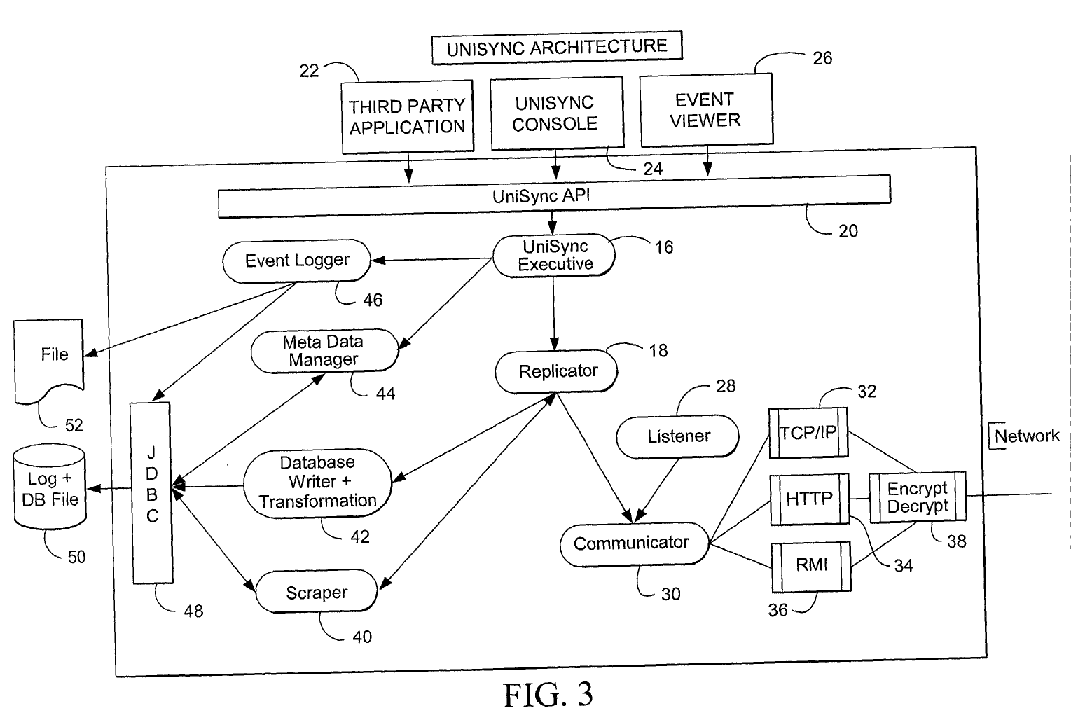

FIG. 3 provides a block diagram of the architecture for the UniSync technology.

4.4 Communicator architecture

4.4.1 Objectives
Support sends and receives data
Support multiple protocols: TCP/IP, HTTP and RMI (HTTPS and SSL)
Support multiple formatting protocols (Serialized object, XML, etc . . . )
Support Row Set as input/output
Dynamic IP address
Able to talk to non-JDBC server (SMTP, file, . . . )

4.4.2 Communicator Overview

4.4.2.1 Background

The UniSync communications components provide communications between two UniSync engines over a network. These components isolate the details of protocols and formats from the rest of UniSync. Per the UniSync design, the basic unit of data that is sent via the communications components is a Java Rowset. None of the communications components are aware of the meaning of the contents of these Rowsets. The formatting components convert Rowsets into data that can be sent across a network, and the transport components send that data over a variety of protocols. The transport components are unaware of what sort of data they are transporting.

4.4.2.2 Formats

Data to be sent over a network may be formatted in a number of ways, including Java Serialized Objects, XML, tab-separated, etc. This formatting is carried out by classes in the com.PointBase.unisync.comm.format package, initially Java Serialized objects will be the only format supported, but others such as XML will be added.

4.4.2.3 Transports

Transport components move data over a network. They view the data to send as a sequence of bytes, and are ignorant of the content of those bytes. This allows the data formats to change without requiring changes to the transport components. The transport components are implemented as Java classes in the com.PointBase.unisync.comm.transport package. Initially, TCP/IP sockets and HTTP will be supported. The transports are based on a action-response metaphor, where one side will send a request to the other side and wait for the other side's response. This implies that the communication channel is not symmetrical; the other side cannot initiate a request. This is done for several reasons: it maps directly onto HTTP, which also works this way and is likely to become on of the most-used transports for Unisync, and it makes the initiator-side much simpler, as it doesn't need a separate thread blocking on the transport waiting for incoming data.

4.4.2.4 Class Design

Publishers publish by sending Unisync commands (some of which include RowSets) to an instance of a class derived from AbstractPubCommunicator. This class defines methods for connecting, disconnecting, and transacting data. Transacting data involves sending a request and waiting for the response. The most commonly-used subclass of AbstractPubCommunicator is probably the FormattedPubCommunicator, whose constructor takes an abject of a class derived from AbstractTransport and an object which implements Formatter. Formatter takes a Unisync command object and turns it into a byte array, different classes may do this by serializing the command object, turning it into XML, etc. The transport object then sends this byte array through the transport protocol that it implements, and returns the response as a byte array. The formatter is then used to parse that byte stream back into a response object according to whatever format is being used. The role of the FormattedPubCommunicator object in this scenario is to coordinate the actions of the formatter and communicator.

On the subscriber side, several ways may be used to communicate. Reading data out of a socket is one of them, but if RMI is used as a transport then the RMI daemon may invoke methods directly on a designated object. The initial effort focuses on socket-based communication, which includes TCP/IP, HTTP, and SSL-enabled variants of these.

The subscriber uses one port for each type of transport used to communicate with it. For example, some publishers may send their data via HTTP, some via HTTPS, and others via simple sockets. Each time a new logical connection is received a transport object of the appropriate type is created and associated with a worker thread. The transport object then reads enough bytes from the transport to ascertain which mapping the connection is for, and if the subscriber allows the connection then the transport object passes its data payload to a formatter object, which decodes the raw bytes into a Unisync command object. These command objects are then passed to a SubCommunicator object, which is responsible for interfacing with the rest of Unisync. Responses are returned in a similar manner but the process is reversed in sequence.

4.4.2.5 Authentication and Encryption

The communication components do not themselves handle issues related to authentication or access control; this is the function of higher-level components. However, if an encrypting transport object is used then the communication components do handle encryption. In addition, if a transport such as HTTP or SSL over sockets is used then it handles authentication, however, this still does not resolve the issue of if a given user should be allowed to publish to or subscribe to a given mapping.

4.4.2.6 Diagram

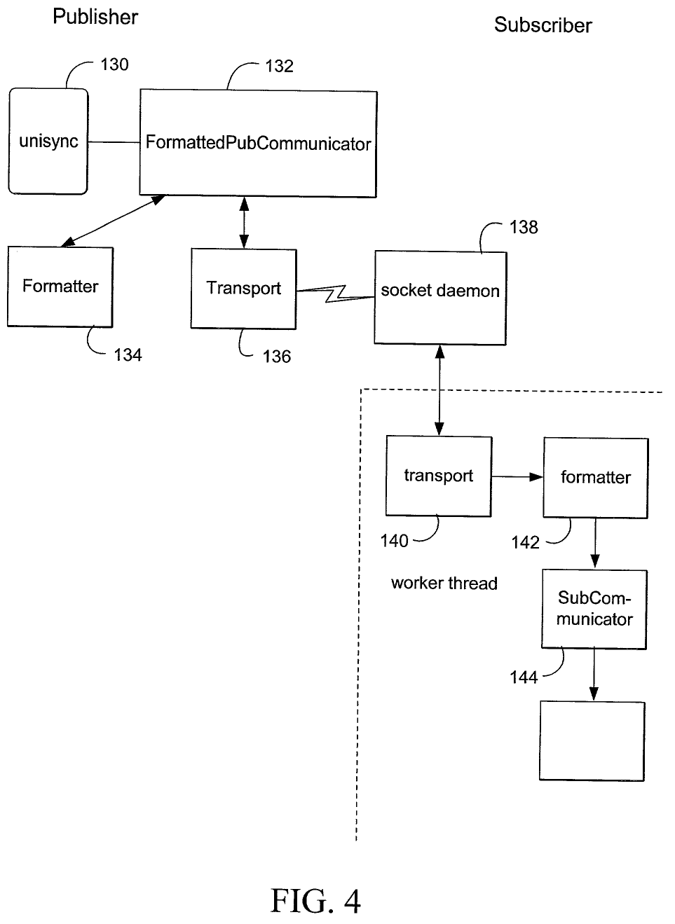

FIG. 4 shows the basic components mentioned above.

4.5 Scraper Architecture

4.5.1 Objectives
Use of JDBC for Snapshot
Use of JDBC for Log Access
Generate Row Set objects
Resolve Log Synchronization Issue (Single JVM)

4.5.2 Scraper Diagram

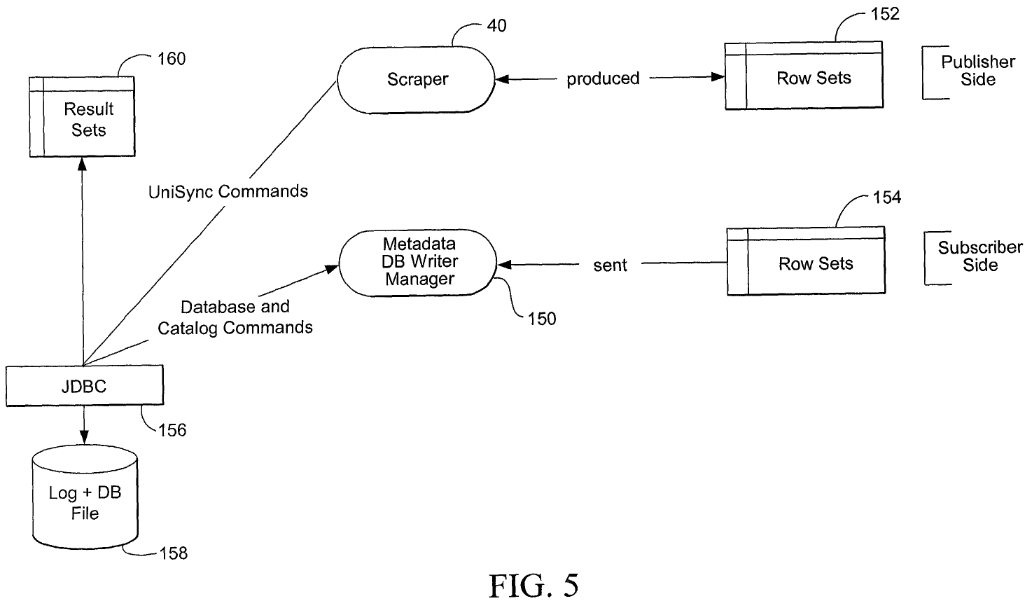

FIG. 5 provides a block diagram of the scraper/reader architecture.

4.6 Log Access through JDBC

The basic idea is to build a multiple result sets returned by JDBC when the UniSync command is executed.

4.6.1 Requirements

Here are the requirements that I thought might drive this issue:
Have one result set per table since all the rows are the same (assuming we add null values if the row is not complete)
Avoid having one result set per log entry for performance reason (The number of result set could be very big if the number of entries in the log is very high).

Avoid having to sort/group log entries coming back from log on a transaction basis. The commit will be the last entry for each transaction.

Use the same mechanism for the snapshot command by using a command such as “UniSync snapshot . . . ”

4.6.2 UniSync Log Access Commands

We have created two JDBC commands to access the PointBase Database Log. The UniSync Snapshot command, which handles multiple tables and does the locking and the UniSync Update command which returns log entries coming from the log. The current syntax is the following:

© PointBase, Inc. 2000
unisync_snapshot ::=
UNISYNC SNAPSHOT table_reference [ ( column_list ) ]

[ { , table_reference [ ( column_list ) ] } ... ]
[ WHERE search_condition ]

unisync_update ::=
UNISYNC UPDATE table_reference [ ( column_list ) ]

[ { , table_reference [ ( column_list ) ] } ... ]
[ WHERE search_condition ]
USING lns_spec

lsn_spec ::=

LSN_START_ID = lsn_int_value AND
LSN_START_OFFSET =

lsn_int_value
AND LSN_SKIP_ID = lsn_int_value AND
LSN_SKIP_OFFSET =
lsn_int_value

AND LSN_CURRENT_ID = lsn_int_value AND

LSN_CURRENT_OFFSET =
lsn_int_value

4.6.3 UniSync Snapshot Command

The UniSync Snapshot Command executed under JDBC will provide the user the locking mechanism and will return multiple result sets (one result set per table). This command will also return another result set (last one) which describe the following bookmarks:
start bookmark
skip bookmark
current bookmark

4.6.3.1 Example

Let say we have 2 tables T1 and T2 in the snapshot command:

Command:

UniSync Snapshot T1, T2;
   Produced Result Sets:
   T1 Result Set:
T1 Meta data
Row1
Row2
Row3
   T2 Result Set:
T2 Meta data
Row1
Row2
Row3
Row4
   Bookmark Result Set:
Bookmark meta data
Start LSN
Skip LSN
Current LSN

4.6.4 UniSync Update Command

4.6.4.1 Log Entry Structure

We have added/changed member variables in the replication entry objects. The old bookmark is now split in 3 different bookmarks, a start, skip and current bookmarks. We have added a boolean flag to differentiate between old and new values for updates. We have also added a pointer to the result set which contains the table row described in the entry. The following is a description of the entry member variables:

| | | |
|---|---|---|
| private int | m_TransactionId; | // transaction id |
| private byte | m_JournalKind; | // T: table, R: row |

| | | |
|---|---|---|
| private byte | m_OperationType; | // I: insert, D: delete, U: |
| update, C: Commit | | |
| private String | m_SchemaName; | // name of the schema |

| | | |
|---|---|---|
| private String | m_TableName; | // name of the table |
| private Timestamp | m_Timestamp; | // timestamp of |
| transaction | | |
| private int | m_fileStartLSN; | // start LSN |
| private int | m_OffsetStartLSN | |
| private int | m_FileSkipLSN; | // skip LSN |
| private int | m_OffsetSkipLSN | |
| private int | m_FileCurrentLSN; | // current LSN |
| private int | m_OffsetCurrentLSN | |

private jdbc20IsyncRowSet m_RowSet

// RowSet containing both old and new
// values. Metadata is also part of this.

Issues:
Metadata
Blobs
How to handle old or new values in rowset (flag?)

4.6.4.2 Result Set Types

There will 2 types of result sets:
One Log Entry Result coming first which has Log Entry Meta data and Log entries (accessed through next command). This result set serves a an index to the rows returned in table result sets.

N Regular Table Result Sets where each result set contains meta data and row entries.

4.6.4.3 Example

Let say we have 3 tables and 3 transactions with the following entries in the log:

Trxn1:

insert T1
insert T1
insert T2
insert T1
commit
   Trxn2:
insert T1
insert T2
insert T3
commit
   Trxn3:
insert T1
delete T2
insert T3
delete T1
update T1
commit
   Result Sets Produced:
   Log Entry Result Set:
   Metadata Result Set
   Transactions/Log entries
      T1 RS, Log entry info, 1 (index in Result Set)
      T1 RS, Log entry info, 2
      T2 RS, Log entry info, 1
      T1 RS, Log entry info, 3
      commit, Log entry info
      T1 RS, Log entry info, 4
      T2 RS, Log entry info, 2
      T3 RS, Log entry info, 1
      commit, Log entry info
      T1 RS, Log entry info, 5
      T2 RS, Log entry info, 3
      T3 RS, Log entry info, 2
      T1 RS, Log entry info, 6
      T1 RS, Log entry info, 7
      commit, Log entry info
         T1 Result Set
   T1 Meta data
   1. insert T1
   2. insert T1
   3. insert T1
   4. insert T1
   5. insert T1
   6. delete T1
   7. update T1
      T2 Result Set
   T2 Meta data
   1. insert T2
   2. insert T2
   3. delete T2
      T3 Result Set
   T3 Meta data
   1. insert T3
   2. insert T3

4.7 UniSync Meta Data

4.7.1 Sites, Publishers and Subscribers Catalog

© PointBase, Inc. 2000
---------- SysSite
CREATE TABLE sysSite

(SiteName varchar(128) not null primary key,
Address varchar(256),

Creation timestamp default current_timestamp)
---------- SysDatabases
CREATE TABLE SysDatabases

| | |
|---|---|
| (SiteName | varchar(128) not null |

| | |
|---|---|
| DatabaseName | varchar(128) not null , |

| | |
|---|---|
| Url | varchar(128) not null, |
| Driver | varcher(128) not null, |

| | |
|---|---|
| DatabaseVendor | varchar(1280 not null, |

Primary key (SiteName, DatabaseName)
);

Note: the user will provide User Name and Password.
---------- SysPublisher
CREATE TABLE SysPublisher

(PublisherName varchar(128) not null primary key,
SiteName varchar(128) not null, /* foreign key */
DatabaseName varchar(128),
)

---------- SysSubscriber
CREATE TABLE SysSubscriber

(SubscriberName varchar(128) not null primary key,
SiteName varchar(128) not null, /* foreign key */
DatabaseName varchar(128),
)

4.7.2 Protocols Table

----------- SysProtocols
CREATE TABLE SysProtocols

| | |
|---|---|
| (SiteName | varchar(128) not null, |

/* foreign key and part of

primary key */

| | |
|---|---|
| TransportProtocol | varchar(128) not null, |

/* TCP/IP or HTTP or

MAIL or RMI */

| | |
|---|---|
| FormattingProtocol | varchar(128) not null, |

/* SERIAL or XML */

| | |
|---|---|
| Address | varchar(256), |

| | |
|---|---|
| Active | boolean, |

Primary Key (SiteName, TransportProtocol,
FormattingProtocol)
)

4.7.3 Publications, Subscriptions and Mappings Catalog

---------- SysMappings
CREATE TABLE SysMappings

(MappingName varchar(128) not null primary key

SubscriptionName varchar(128) not null,
PublicationName varchar(128) not null,
Bookmark binary(256),

Creation timestamp default current_timestamp
)

---------- SysPublications
CREATE TABLE SysPublications

(PublicationName varchar(128) not null,

publisherName varchar(128) not null, /* foreign key */

OnCommit boolean,
Creation timestamp

)

---------- SysPublicationTables
CREATE TABLE SysPublicationTables

(PulicationTableId Integer not null primary key,

PublicationName varchar(128) not null,
SchemaName varchar(128) not null,
TableName varchar(128) not null,
ChunkSize integer,
PublicationFilter varchar(1000),
OrdinalNumber integer

)

---------- SysPublicationColumns
CREATE TABLE SysPublicationColumns

(PublicationTableId integer not null, /* foreign key */

TransformedColumnName varchar(1000) not null,

OrdinalPosition integer

)

---------- SysSubscriptions
CREATE TABLE SysSubscriptions

(SubscriptionName varchar(128) not null,

subscriberName varchar(128) not null, /* foreign key */

Creation timestamp

)

---------- SysSubscriptionTables
CREATE TABLE SysSubscriptionTables

(SubscriptionTableId Integer not null primary key,

SubscriptionName varchar(128) not null,
SchemaName varchar(128) not null,
TableName varchar(128) not null,
SubscriptionFilter varchar(1000),
SnapshotCompletedFlag boolean

)

---------- SysSubscriptionColumns
CREATE TABLE SysSubscriptionColumns

(SubscriptionTableId integer,
TransformedColumn varchar(1000) not null,
OrdinalPosition integer,

ConflictResolution varchar(1000)

)

---------- SysTableMappings
CREATE TABLE SysTableMappings

(TableMappingId integer,

PublicationTableId integer,
SubscriptionTableId integer)

---------- SysTableColumnMappings
CREATE TABLE SysTableColumnsMappings

(TableMappingId integer,

PublicationColumnName varchar(128) not null,
SubscriptionColumnName varchar(128) not null

)

4.7.4 Propagation Catalog

---------- SysPropagation
CREATE TABLE SysPropagation

(TransactionID integer,

SubscriberName varchar(128)

)

4.7.5 Optional Event Log Catalog

---------- SysLogEvents
CREATE TABLE SysLogEvents

(event_timestamp timestamp,

log_type varchar(50),
log_sub_type varchar(50),
description varchar(128)

)

---------- SysTraceEvents
CREATE TABLE SysTraceEvents

(event_timestamp timestamp,

module_name varchar(50),
method_name varchar(50),
description varchar(128)

)

4.7.6 Generic Parameters Table

----------- SysParameters
CREATE TABLE SysParameters

(ParamName varchar(128) primary key,

ParamType integer not null,
IntegerValue integer,
CharValue varchar(2000),

DateTimeValue datetime,
BooleanValue Boolean
)

4.8 Bridge and Interfaces

4.8.1 UniSync API

The current UniSync API will be adapted to the new architecture. Mainly it will be extended to handle the “push” and “pull” commands.

4.8.2 Configuration File

All the UniSync settings will be grouped in one file called UniSync.ini, which will act, like the pointbase.ini file for the database. For example we will have the following parameters:

© PointBase, Inc. 2000

| | |
|---|---|
| unisync.home = c:\unisync | // default c:\unisync |
| documentation.home = \unisync\docs | // default c:\unisync\docs |
| server.port = 2000 | // default : 2000 |

| | |
|---|---|
| communication.protocol = tcpip/http/rmi | // default : http |

| | |
|---|---|
| communication.format = serial/xml | // default : serial |

| | |
|---|---|
| unisync.filtering = on/off | // default: off |
| unisync.transformation = on/off | // default : off |

| | |
|---|---|
| unisync.conflict_resolution = on/off | // default : off |

| | |
|---|---|
| unisync.logfile = c:\temp\logfile.txt | // default : |

logfile.txt

| | |
|---|---|
| unisync.tracefile = c:\temp\tracefile.txt | // default : |

tracefile.txt

| | |
|---|---|
| unisync.log = on/off | // default : off |
| unisync.trace = on/off | // default : off |
| security.enabled = true/false | // default : true |

| | |
|---|---|
| recovery.snapshot = table/n rows | // default : table |
| recovery.update = transaction / n rows | // default : |

transaction

4.8.3 Bridge with DataMirror Products

A very simple bridge will be build to access DataMirror engines and to exchange data.

5. Objectives & Scope of Conflict Resolution

This document specifies the updates conflict detection and resolution mechanism for PointBase Uni Sync option. In this document we are dealing only with update conflicts. Other conflicts such as uniqueness key conflicts and delete conflicts are not part of this document.

6. Introduction to Conflict Resolution

Replication conflicts can occur in synchronization environments that permit concurrent updates to the same data at multiples spokes. For example, when two transactions originating from different sites update the same row at nearly the same time, a conflict can occur.

UniSync supports an optional conflict resolution mechanism. You can set “on” or “off” the conflict resolution mechanism depending of your environment. It is feasible in certain environment; it may not be possible in some other environment. Conflict resolution is often not possible in reservation systems. For example, a seat in a flight reservation cannot be updated by two transactions at the same time. Conflict resolution is often possible in customer management systems. For example, customer address information is updated at different spokes.

The hub detects conflicts if there is a difference between the original value of the replicated field on the spoke (the value before the modification) and the current values of the same field at the hub.

To detect synchronization conflicts accurately, UniSync must be able to uniquely identify and match corresponding rows across different systems. UniSync uses the primary key of a table to uniquely identify rows in the table. UniSync conflict resolution requires a primary key for each synchronized table.

UniSync recognizes conflicts during point update operations and not during snapshot.

7. Scenario Example for Conflict Resolution

Table stock: item_id (primary key), item_name, number_of_items_{—}
available
State 1: starting point

| | |
|---|---|
| HUB row: | 100, ‘TOOTHBRUSH’, 12 |
| SPOKE row: | 100, ‘TOOTHBRUSH’, 12 |

State 2: hub row updated by hub application
and spoke row updated by spoke application (*)

| | |
|---|---|
| HUB row: | 100, ‘TOOTHBRUSH’, 10 (sold 2 items: update |
| | executed on hub) |
| SPOKE row: | 100, ‘TOOTHBRUSH’, 11 (sold 1 item: update |
| | executed on spoke) |

State 3: replicate from spoke to hub

| | |
|---|---|
| HUB row: | 100, ‘TOOTHBRUSH’, 9 (**) |
| SPOKE row: | 100, ‘TOOTHBRUSH’, 11 |

State 4: replicate from hub to spoke (hub and spoke synchronized)

| | |
|---|---|
| HUB row: | 100, ‘TOOTHBRUSH’, 9 |
| SPOKE row: | 100, ‘TOOTHBRUSH’, 9 (***) |

Notes:
(*): We can have a same example where the updates are coming from 2
different spokes.
(**): Here we added all the items sold and updated the hub.
(***): We cannot update the same row on spoke while we are executing the
getPointUpdate from hub. These two operations are mutually exclusive.

8. Specification for Conflict Resolution

8.1 Detection and Resolution

A Conflict in UniSync synchronization can be either ignored, only detected or both detected and resolved.

Conflicts are always detected and resolved on the single point of synchronization (i.e. the hub server). Conflict handling algorithms reside on the hub only. When conflicts are resolved, merged rows are replicated back to spokes as “is” (without any conflict checking on the spokes).

There are many ways to address conflicts:
a. Ignore: you can ignore the conflicts and apply the changes as they come. There is neither detection nor resolution in this case.
b. Detect only: you can detect the conflict when an update is replicated and refuse the changes (but apply the none conflicting changes).
c. Detect and Resolve: you can detect the conflict, apply some level of conflict resolution provided for that purpose and then apply the changes.
   In case (b) and (c) you can either log or not log the conflicts.

8.2 Conflict Management Policies

8.2.1 Conflict management modes

| Mode | Description |
|---|---|
| IGNORE(LAST_ONE_WINS) | Ignore the conflict and apply |
| | updates as they come |
| DETECTION ONLY | Detect only (do not apply update |
| | for that column if there is conflict |
| | but log the information) |
| DETECTION AND RESOLUTION | Detect, and resolve conflict |
| | according to predefined or user |
| | provided procedure. |

8.2.2 UniSync Support

The UniSync option currently supports the following capabilities.

| Mode | Apply changes? |
|---|---|
| Ignore | Last one always wins. |
| Detect only | No |
| Detect and Resolve | Yes |

Logging the conflicts:

| Mode | Log conflict | Do not log conflict |
|---|---|---|
| Ignore | N/A | N/A |
| Detect only | Yes | N/A |
| Detect and Resolve | Not supported yet. | Yes |

8.2.3 Default Resolution Types

| Type | Description |
|---|---|
| SPOKEWINS | For all the conflicts detected apply |
| | spoke wins procedure |
| HUBWINS | For all the conflicts detected apply |
| | hub wins procedure |
| DETECTONLY | For all the conflicts detected, log |
| | information in the hub but do not |
| | apply for that column |

8.2.4 Customized Conflict Resolution Procedures

UniSync provides the ability to override the default conflict resolution types defined below by setting the resolution type to “CUSTOMIZED”. This means the default conflict resolution type can bde

Predefined Conflict Resolution Procedures:
INCREMENTDECREMENT <numeric only> value=currentValue+(newValue−oldValue)
CONCATENATE <text only><regular string concatenation>
SPOKEWINS <all datatypes><spoke value wins over hub value>
HUBWINS <all datatypes><hub value wins over spoke value>
DETECTONLY <all datatypes><detection only; info is logged on hub>
oldValue is the spoke value sent by the hub (before any update on spoke)
newValue is the column updated value on spoke after the update.
currentValue is the column value on the hub.

User defined conflict resolution procedure:
USER_PROCEDURE <all datatypes><user procedure according to a provided interface.>

Conflict Resolver Interface:

When a programmer would like to write a conflict resolver procedure he/she will have to follow the following interface:

© PointBase, Inc. 2000
public interface syncConflictResolver
{

/**

* setContext sets the conflict resolution context
to allow the user procedure

to run

* @param p_Context syncConflictContext to set up
* @exception syncException thrown in case an
unexpected error occurs.
*/

| | |
|---|---|
| public | void setContext(syncConflictContext |

| | |
|---|---|
| p_Context) | throws |

syncException;

/**

* getContext returns the current syncConflictContext
Object
* @return syncConflictContext returned context
* @exception syncException thrown in case an
unexpected error occurs.
*/

public syncConflictContext getContext( ) throws
syncException;

/**

* resolve.
* @param oldValue old spoke object value
* @param newValue new spoke object value
* @param currentValue current object value
* @exception syncException thrown in case an
unexpected error occurs.
*/

public Object resolve(Object oldValue, Object
newValue, Object

currentValue)
throws syncException;
}

8.3 Parameters in the unisync.ini File

8.3.1 Description

The conflict management mode (conflictManagementMode parameter in unisync.ini) takes two values: “on” means that the conflict resolution mechanism is on in the hub and “off” means UniSync does not detect any conflict and applies the changes as they come. The default value is “off”.

The conflict resolution type (conflictResolutionType parameter in unisync.ini) takes four values: “spokewins” which means in a case of a conflict the spoke value wins over the hub value; “hubwins”” which means in a case of a conflict the hub value wins over the spoke value; “detectonly” means we do not resolve the conflict but we log the conflict and it's environment on the hub; and “customized” means the resolution procedure attached to the field is applied to resolve the conflict. If no value is attached to the column then the default resolution procedure is applied. The default value is “spokewins.”

The conflict resolution default procedure (conflictResolutionDefault parameter in unisync.ini file) take any value (a class name) as soon as they class is in the CLASSPATH and is extending the conflictResolverImpl class (see com.pointbase.unisync.resolver.resolverSample). The default value is “com.pointbase.unisync.resolver.resolverApplySpokeWins.”

8.3.2 Unisync.ini Example
conflict.managementMode=on
conflict.resolutionType=customized
conflict.resolutionDefault
com.pointbase.unisync.resolver.resolverApplySpokeWins

9. High Level Design for Conflict Resolution

9.1 New Packages: Detection and Resolution

9.1.1 Detection Package

This package deals with the spoke rowset and the hub rowset. It detects all the conflits and returns them via an enumerator provide for that purpose. Here is a skeleton of the class:

© PointBase, Inc. 2000
public class conflictDetection
{

| | | |
|---|---|---|
| private jdbc20ISyncRowSet | m_HubData | = null; |

| | | |
|---|---|---|
| private jdbc20ISyncRowSet | m_SpokeData | = null; |

| | | |
|---|---|---|
| private conflictContextImpl | m_Conflict | = null; |

| | | |
|---|---|---|
| private boolean | m_HasMoreConflicts | = |

false;

etc ...

/**

* Constructor
*/

public

conflictDetection (

jdbc20ISyncRowSet p_HubData,

jdbc20ISyncRowSet p_SpokeData

etc ...

)

throws syncException

{

m_HubData = p_HubData;
m_SpokeData = p_SpokeData;

...

}

public void

startDetection( )

throws syncException

{

...

}

public boolean

hasMoreConflicts( )

throws syncException

{

....

}

public syncConflictContext

nextConflict( )

throws syncException

{

return m_Conflict;

}

}

9.1.2 Resolution Package

This package deals with the spoke rowset and the hub rowset. It resolves the conflicts provided by the detection package. This package returns basically the merged row once all the conflicts are resolved. Here is the skeleton of the class:

© PointBase, Inc. 2000
public class conflictResolution
{

| | |
|---|---|
| private syncxInternalCatalog m_Catalog | = null; |

| | |
|---|---|
| private jdbc20ISyncRowSet m_HubData | = null; |
| private jdbc20ISyncRowSet m_SpokeData | = null; |

| private String | m_ConflictResolutionMode = null; | |
|---|---|---|
| private String | m_ResolutionType | = null; |

| | | |
|---|---|---|
| private String | m_CustomizedDefault | = null; |

| | | |
|---|---|---|
| private Object[] | m_Conflicts | = null; |
| /** | | |

* Constructor
*
*/

public

conflictResolution ( syncxInternalCatalog p_Catalog,

jdbc20ISyncRowSet p_HubData,

jdbc20ISyncRowSet p_SpokeData

etc ...

)

throws syncException

{

m_Catalog = p_Catalog;
m_HubData = p_HubData;
m_SpokeData = p_SpokeData;
m_ConflictResolutionMode =

p_props.getProperty(iniDefaults.ConflictResolutionModeKey);

m_ResolutionType =

p_props.getProperty(iniDefaults.ConflictResolutionTypeKey);

m_CustomizedDefault =

p_props.getProperty(iniDefaults.CustomizedResolutionDefaultKey);

...

}

public jdbc20ISyncRowSet

resolve( )

throws syncException

{

if (m_ConflictResolutionMode.equalsIgnoreCase (“true”))
{

return doResolution( );

}
else
{

throw new syncException(“Unexpected Conflict
Res. Mode :” +

m_ConflictResolutionMode + “.”);

}

}

public boolean
thereIsConflict( )

throws syncException

{

...

}

private jdbc20ISyncRowSet

doResolution( )

throws syncException

{

conflictDetection l_Conf = new
conflictDetection( m_HubData,

m_SpokeData, etc ...);

l_Conf.startDetection( );
if (l_Conf.hasMoreConflicts( )) // conflict is
detected - resolution follows
{

....

}
else // so no conflict return spoke
{

return m_SpokeData;

}

}

private jdbc20ISyncRowSet

doDetection( )

throws syncException

{

...

}

private jdbc20ISyncRowSet

doCustomizedResolution(conflictDetection p_ConflictDetection, boolean
p_DetectOnly)

throws syncException

{

...

}

private Object

executeUserProc ( String p_UserProc, conflictContextImpl

p_ConflictContext)

throws syncException

{

...

}

private Object[]

mergeRowForDetection(Object[] p_Conflicts)

throws syncException

{

...

}

private Object[]

mergeRowForResolution(Object[] p_Conflicts)

throws syncException

{

...

}

}

9.2 Conflict Resolution Infrastructure

9.2.1 Handling Conflict Detection and Resolution in the Atabase Writer

The following will be added to the databasWriter class in the writeRowSet method:

if ((thisSite == “hub”) and (operation == update))
{

if (conflictResolutionMode = “on”)
{

conflictResolution l_conf = new conflictResolution(

getDataConnection( ).getInternalCatalog( ),
l_Hub,
p_Data, ....

);

l_MergedData = l_conf.resolve( );
...
if (l_conf.thereIsConflict( ))

m_IsConflict = true;

}
else
{

<do regular updates>

}

}

9.2.2 Conflict Context Interface

© PointBase, Inc. 2000
public interface syncConflictContext
{

/**

* getUserName.
* @exception syncException thrown in case an unexpected
error occurs.
*/

public String

getUserName( )

throws syncException;

/**

* getTableName.
* @exception syncException thrown in case an unexpected
error occurs.
*/

public String

getTableName( )

throws syncException;

/**

* getColumnName.
* @exception syncException thrown in case an unexpected
error occurs.
*/

public String

getColumnName( )

throws syncException;

/**

* getColumnType.
* @exception syncException thrown in case an unexpected
error occurs.
*/

public int

getColumnType( )

throws syncException;

}

9.2.3 Conflict Resolver Interface

public interface syncConflictResolver
{

/**

* setContext sets the conflict resolution context to
allow the user procedure

to run

* @param p_Context syncConflictContext to set up
* @exception syncException thrown in case an
unexpected error occurs.
*/

public void

setContext(syncConflictContext p_Context)

throws syncException;

/**

* getContext returns the current syncConflictContext
Object
* @return syncConflictContext returned context
* @exception syncException thrown in case an
unexpected error occurs.
*/

public syncConflictContext

getContext( )

throws syncException;

/**

* resolve.
* @param oldValue old spoke object value
* @param newValue new spoke object value
* @param currentValue current object value
* @exception syncException thrown in case an
unexpected error occurs.
*/

public Object

resolve(Object oldValue, Object newValue, Object currentValue)

throws syncException;

}

9.2.4 Conflict Context Implementation

public class conflictContextImpl

implements syncConflictContext

{

| | | |
|---|---|---|
| private String | m_UserName | = null; |
| private String | m_TableName | = null; |

| | | |
|---|---|---|
| private String | m_ColumnName | = null; |

| | | |
|---|---|---|
| private int | m_ColumnType | = 0; |

| | | |
|---|---|---|
| private int | m_ColumnPosition | = 0; |

| | | |
|---|---|---|
| private Object | m_CurrentValue | = null; |

| | | |
|---|---|---|
| private Object | m_OldValue | = null; |
| private Object | m_NewValue | = null; |
| /** | | |

* Constructor
*/

public

conflictContextImpl( String p_UserName, String p_TableName)

throws syncException

{

m_UserName = p_UserName;
m_TableName = p_TableName;

}
/**

* getUserName.
* @exception syncException thrown in case an unexpected
error occurs.
*/

public String

getUserName( )

throws syncException

{

return m_UserName;

}
/**

* getTableName.
* @exception syncException thrown in case an unexpected
error occurs.
*/

public String

getTableName( )

throws syncException

{

return m_TableName;

}
etc ..... (getters and the setters).

}

9.2.5 Conflict Resolution Procedure Example

This procedure is written/provided in java by the user/application programmer. The logic on how the conflict is resolved is decided by the user/programmer.

public class resolverSample

extends resolverImpl

{

/**

* resolve.
*
* @param oldValue old spoke object value
* @param newValue new spoke object value
* @param currentValue current object value
* @exception syncException thrown in case an unexpected
error occurs.
*/

public Object

resolve(Object oldValue, Object newValue, Object currentValue)

throws syncException

{

syncConflictContext l_crContext = getContext();
if (l_crContext.getUserName( ) == “Manager”)
{

return oldValue;

}
else
{

return newValue;

}

}

}

9.3 Enhancement to the Database Log Scraping

9.3.1 Introduction

We need to enhance database log scraping algorithm to handle the needs of conflict resolution mechanism of Unisync. This work is being done to help Unisync conflict resolution mechanism. Currently the log-scraping algorithm (UNISYNC UPDATE command implementation) handles propagation of updates. Ie Deltas pushed by a spoke SI will not come back to the same spoke but to other spokes. That logic has to be enhanced to allow propagation of ‘resolved’ updates to come back to the same spoke which is pushing it.

9.3.2 Description

The key components of this work include:
a) Implement UNISYNC LOG_MARKER command, which should log Unisync marker records to the database log.
b) Fix the database code which processes log records to ignore Unisync marker records.
c) Make databaseWriter use the UNISYNC LOG_MARKER command before and after it issues a ‘conflict resolved’ update.
d) Enhance the log scraper algorithm to be aware of Unisync marker log records. It should replicate all records within a BEGIN and END Unisync marker records.

The requirements of this project will be achieved as follows. A SQL command:

UNISYNC LOG_MARKER <marker_type>[other info]

will be implemented, which will log a UNISYNC MARKER log record with the given marker type (integer) and an optional additional info(String). Database is supposed to skip such log records if found while it processes the log file. Unisync will make use of this command. The databaseWriter should issue a

UNISYNC LOG_MARKER 1;

before it issues a ‘conflict resolved’ update. The marker type 1 means BEGIN INCLUDE. databaseWriter would issue a regular UPDATE command with the resolved values. It would then issue a,

UNISYNC LOG_MARKER 2;

The marker type 2 means END INCLUDE. These records will be used to propagate the conflict resolved updates back to spoke when the spoke issues a getPointUpdate. When a UNISYNC UPDATE command is issued during the getPointUpdate operation, the scraper algorithm normally rejects a transaction if it is done as a part of a previous putPointUpdate by the same spoke (this is called the propagation issue). Now, the algorithm has to be enhanced to include only those records within a BEGIN INCLUDE and END INCLUDE marker records for transactions that are rejected due to propagation (transactions with site name attached to COMMIT record).

9.3.3 Syntax and Semantic Implications

A new SQL command has to be implemented:

UNISYNC LOG_MARKER <marker_type>[optional_info]

This should create a new log record of type UNISYNC MARKER record, tag it with the marker_type as the sub type, add optional_info if given and log it to the database log.

9.4 Metadata Changes

9.4.1 Resolution Procedures

The ConflictResolution field is added to the SysSyncPublicationDataField table:

CREATE TABLE SysSyncPublicationDataField

(
DataFieldId INT NOT NULL,
DataItemId INT NOT NULL,
DataFieldName VARCHAR(128) NOT NULL,
DataFieldType INT NOT NULL,
DataFieldSize INT NOT NULL,
DataFieldScale INT NOT NULL,
ConflictResolution VARCHAR(255),
OrdinalNumber INT NOT NULL
)

9.4.2 Unresolved Conflicts

Unresolved conflicts are stored in SysSyncUnresolvedConflicts and their conflicting columns and keys are stored in SysSyncConflictingFields:

CREATE TABLE SysSyncUnresolvedConflicts

(
ConflictId INT,
SiteName VARCHAR(128) NOT NULL,
PublicationName VARCHAR(128) NOT NULL,
TableName VARCHAR(128) NOT NULL
)

CREATE TABLE SysSyncConflictingFields

(

ConflictId INT,

IsPrimaryKey BOOLEAN,
ColumnName VARCHAR(255) NOT NULL,

ValueType INT NOT NULL,
FieldValue BLOB

)

The following is the current list of predefined resolver procedures. The user can invoke them by setting them in the rowsetPublicationDataField or as a default resolution procedure in the unisync.ini file.

com.pointbase.unisync.resolver.resolverApplyHubWins

com.pointbase.unisync.resolver.resolverApplySpokeWins

com.pointbase.unisync.resolver.resolverConcatenate

com.pointbase.unisync.resolver.resolverDetectOnly

com.pointbase.unisync.resolver.resolverIncrementDecrement

FIG. 6 is a block diagram of the components of a computer system that can be used to implement the present invention. For example, computing system 30 can be implemented according to FIG. 2 or any other suitable architecture known in the art. The computer includes a processor 102, a memory 104, a mass storage device 106, a portable storage device 108, a database 110, a network interface 112 and I/O devices 114. The choice of processor is not critical as long as a suitable processor with sufficient speed is chosen. Memory 104 could be any conventional computer memory known in the art. Mass storage device 106 could include a hard drive, CD-ROM or any other mass storage device. Portable storage 108 could include a floppy disk drive or other portable storage device. If the computer is acting as a router, it may include two or more network interfaces 112. In other embodiments, the computer could include only one network interface. The network interfaces can include network cards for connecting to an Ethernet or other type of LAN. In addition, one or more of the network interfaces can include or be connected to a firewall. For a gateway, one of the network interfaces will typically be connected to the Internet and the other network interface will typically be connected to a LAN. However, a gateway can exist physically inside a network. I/O devices 114 can include one or more of the following: keyboard, mouse, monitor, display, printer etc. Software used to perform the methods of the present invention are likely to be stored in mass storage 106 (or any form of non-volatile memory), portable storage media (e.g. floppy disk or tape) 108 and, at some point, in memory 104. Various embodiments, versions, and modification of the system of FIG. 6 can be used to implement a computing device that performs all or part of the present invention.

The foregoing detailed description of the invention has been presented for purposes of illustration and description. It is not intended to be exhaustive or to limit the invention to the precise form disclosed, and obviously many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. A method for synchronizing data, comprising the steps of:
transmitting a set of one or more changes from a hub to a spoke for synchronization to a data structure on said spoke, said set of one or more changes represent changes to a data structure on said hub, said step of transmitting a set of one or more changes includes accessing a log entry for a particular change and transmitting said particular change to said spoke if said log entry for said particular change does not indicate an association with said spoke; and
updating said data structure on said spoke based on said set of one or more changes.

2. A method according to claim 1, wherein:
said log entry indicates an association with said spoke if said log entry includes a site name for said spoke attached to a commit record for said log entry.

3. A method according to claim 1, wherein:
said step of transmitting a set of one or more changes includes transmitting said particular change to said spoke if said log entry indicates an association with said spoke and said particular change was a result of conflict resolution.

4. A method according to claim 3, wherein said step of transmitting a set of one or more changes includes the step of:
determining whether said particular change resulted from conflict resolution by determining whether said log entry for said particular change is positioned within markers in a log for said data structure on said hub.

5. A method according to claim 1, further comprising the steps of:
transmitting a first change from said spoke to said hub, said first change represents one or more changes to said data structure on said spoke; and
updating said data structure on said hub based on said first change.

6. A method according to claim 5, wherein said step of updating a data structure on said hub includes the steps of:
determining whether a data value on said spoke is in conflict with a corresponding data value on said hub;
updating said corresponding data value on said hub if said data value on said spoke is not in conflict with said corresponding data value on said hub;
resolving said conflict if said data value on said spoke is in conflict with said corresponding data value on said hub, said step of resolving produces a result; and
storing said result on said hub.

7. A method according to claim 6, wherein:
said step of transmitting a set of one or more changes includes transmitting said result to said spoke, said hub stores a log entry for said result, said log entry for said result indicates an association with said spoke.

8. A method according to claim 6, wherein:
said step of resolving said conflict is programmable.

9. A method according to claim 5, wherein:
said steps of transmitting a first change and transmitting a set of one or more changes are programmable such that any one of a set of different communication protocols can be used.

10. A method according to claim 5, wherein:
said data structure on said first spoke is a first proprietary format database; and
said data structure on said hub is a second proprietary format database.

11. A method according to claim 5, wherein:
said step of transmitting a set of one or more changes includes encrypting said additional changes.

12. A method for synchronizing data, comprising the steps of:
accessing a new transaction for a data structure on a hub for synchronization to a data structure on a first spoke;
rejecting said new transaction for synchronization to said data structure on said first spoke if said new transaction originated from said first spoke and said new transaction was not based on conflict resolution; and
transmitting said new transaction to said first spoke if said new transaction did not originate from said first spoke or if said new transaction did originate from said first spoke but was based on conflict resolution.

13. A method according to claim 12, wherein:
said step of accessing a new transaction includes accessing a log entry associated with said new transaction; and
said new transaction originated from said first spoke if said log entry identifies said first spoke.

14. A method according to claim 12, wherein:
said step of accessing a new transaction includes accessing a log entry associated with said new transaction; and
said new transaction originated from said first spoke if a commit record in said log entry identifies said spoke.

15. A method according to claim 12, wherein:
said step of accessing a new transaction includes accessing a log; and
said new transaction was based on conflict resolution if said log includes a marker record indicating conflict resolution.

16. A method according to claim 12, further comprising the step of:
determining whether said new transaction was based on conflict resolution by determining whether log information for said new transaction is positioned within markers in a log for said data structure on said hub.

17. A method according to claim 12, further comprising the step of:
transmitting said new transaction to all spokes that synchronize with said hub other than said first spoke if said new transaction originated from said first spoke and said new transaction was not based on conflict resolution.

18. A method according to claim 12, further comprising the steps of:
receiving said new transaction at said hub; and
resolving a conflict with said new transaction, said step of resolving is programmable.

19. A method according to claim 12, wherein:
said step of transmitting is programmable such that any one of a set of different communication protocols can be used.

20. A method according to claim 12, further comprising the step of:
updating a data structure on said first spoke based on said transmitted new transaction if said new transaction did not originate from said first spoke or if said new transaction did originate from said first spoke but was based on conflict resolution, said data structure on said first spoke is a first proprietary format database and said data structure on said hub is a second proprietary format database.

21. A system for synchronizing data, comprising:
a database reader system, said database reader system is programmable to read from any one of a plurality of different proprietary databases;
a database writer system, said database writer system is programmable to write to any one of said plurality of different proprietary databases; and
a communication system in communication with said database reader system, said database writer system and a remote system, said communication system is programmable to communicate with said remote system using any one of a plurality of different communication protocols.

22. A system according to claim 21, further comprising:
application program interface means for enabling applications to provide synchronization functionality.

23. A system according to claim 21, wherein:
said communication system creates a new object for each connection.

24. A system according to claim 21, further comprising:
an event logger.

25. A system according to claim 21, wherein:
said communication system communicates data as row sets.

26. A system according to claim 21, wherein:
said database reader system rejects data for synchronizing to said remote system if said data is for a transaction that originated from said remote system and was not based on conflict resolution, said database reader system does not reject said data if said transaction did not originate from said remote system or if said transaction did originate from said remote system but was based on conflict resolution.

27. A system according to claim 21, wherein:
said database reader system accesses a log entry for data and rejects said data for synchronizing to said remote system if said log entry identifies said remote system.

28. An apparatus for synchronizing data, comprising the steps of:
means for reading a database, said means for reading a database is programmable to read from any one of a plurality of different proprietary databases;
means for writing to a database, said means for writing to a database is programmable to write to any one of said plurality of different proprietary databases; and
means for communicating, said means for communicating is programmable to communicate with a remote system using any one of a plurality of different communication protocols.

29. A system according to claim 28, further comprising:
application program interface means for enabling applications to provide synchronization functionality.

30. One or more processor readable storage devices having processor readable code embodied on said processor readable storage devices, said processor readable code for programming one or more processors, said processor readable code comprises:
first code, said first code reads a database and can be adapted to read from any one of a plurality of different proprietary databases;
second code, said second code writes to a database and can be adapted to write to any one of said plurality of different proprietary databases; and
third code, said third code communicates with a remote system using any one of a plurality of different communication protocols, said third code can communicate with said first code and said second code.

31. One or more processor readable storage devices according to claim 30, further comprising:
fourth code, said fourth code includes an application program interface that enables applications to provide synchronization functionality.

32. One or more processor readable storage devices according to claim 30, wherein:
said first codes rejects data for synchronizing to said remote system if said data is for a transaction that originated from said remote system and was not based on conflict resolution, said first code does not reject said data if said transaction did not originate from said remote system or if said transaction did originate from said remote system but was based on conflict resolution.

33. One or more processor readable storage devices according to claim 30, wherein:
said first codes accesses a log entry for data and rejects said data for synchronizing to said remote system if said log entry identifies said remote system.

34. One or more processor readable storage devices having processor readable code embodied on said processor readable storage devices, said processor readable code for programming one or more processors to perform a method comprising the steps of:
accessing a change to a data structure on a hub;
accessing a log entry for said change; and
transmitting said change to a spoke for synchronization with a data structure on said spoke if said log entry for said change does not indicate an association with said spoke.

35. One or more processor readable storage devices according to claim 34, wherein:
said log entry indicates an association with said spoke if said log entry includes a site name for said spoke attached to a commit record.

36. One or more processor readable storage devices according to claim 34, wherein:
said step of transmitting said change includes transmitting said change to said spoke if said log entry indicates an association with said spoke and said change was a result of conflict resolution.

37. One or more processor readable storage devices according to claim 36, wherein said step of transmitting said change includes the step of:
determining whether said change resulted from conflict resolution by determining whether said log entry for said change is positioned within markers in a log for said data structure on said hub.

38. One or more processor readable storage devices according to claim 34, wherein:
said data structure on said spoke is a first proprietary format database; and
said data structure on said hub is a second proprietary format database.

39. An apparatus, comprising:
a communication interface;
one or more storage devices; and
one or more processors in communication with said one or more storage devices and said communication interface, said one or more processors programmed to perform a method comprising the steps of:
accessing a change to a data structure on a hub,
accessing a log entry for said change, and
transmitting said change to a spoke for synchronization with a data structure on said spoke if said log entry for said change does not indicate an association with said spoke.

40. An apparatus according to claim 39, wherein:
said log entry indicates an association with said spoke if said log entry includes a site name for said spoke attached to a commit record.

41. An apparatus according to claim 39, wherein:
said step of transmitting said change includes transmitting said change to said spoke if said log entry indicates an association with said spoke and said change was a result of conflict resolution.

42. An apparatus according to claim 41, wherein said step of transmitting said change includes the step of:
determining whether said change resulted from conflict resolution by determining whether said log entry for said change is positioned within markers in a log for said data structure on said hub.

43. An apparatus according to claim 39, wherein said method further comprises the steps of:
transmitting a first change from said spoke to said hub, said first change represents one or more changes to said data structure on said spoke; and
updating said data structure on said hub based on said first change, said data structure on said spoke is a first proprietary format database and said data structure on said hub is a second proprietary format database.

44. One or more processor readable storage devices having processor readable code embodied on said processor readable storage devices, said processor readable code for programming one or more processors to perform a method comprising the steps of:
accessing a new transaction for a data structure on a hub for synchronization to a data structure on a first spoke;
rejecting said new transaction for synchronization to said data structure on said first spoke if said new transaction originated from said first spoke and said new transaction was not based on conflict resolution; and
transmitting said new transaction to said first spoke if said new transaction did not originate from said first spoke or if said new transaction did originate from said first spoke but was based on conflict resolution.

45. One or more processor readable storage devices according to claim 44, wherein:
said step of accessing a new transaction includes accessing a log entry associated with said new transaction; and
said new transaction originated from said first spoke if said log entry identifies said spoke.

46. One or more processor readable storage devices according to claim 44, wherein:
said step of accessing a new transaction includes accessing a log entry associated with said new transaction; and
said new transaction originated from said first spoke if said log entry includes a commit record that identifies said spoke.

47. One or more processor readable storage devices according to claim 44, wherein:
said step of accessing a new transaction includes accessing a log; and
said new transaction was based on conflict resolution if said log includes a marker record indicating said conflict resolution.

48. One or more processor readable storage devices according to claim 44, wherein said method further comprises the step of:
transmitting said new transaction to all spokes that synchronize with said hub other than said first spoke if said new transaction originated from said first spoke and said new transaction was not based on conflict resolution.

49. One or more processor readable storage devices according to claim 44, wherein:
said step of transmitting is programmable such that any one of a set of different communication protocols can be used.

50. An apparatus, comprising:
a communication interface;
one or more storage devices; and
one or more processors in communication with said one or more storage devices and said communication interface, said one or more processors programmed to perform a method comprising the steps of:
accessing a new transaction for a data structure on a hub for synchronization to a data structure on a first spoke,
rejecting said new transaction for synchronization to said data structure on said first spoke if said new transaction originated from said first spoke and said new transaction was not based on conflict resolution, and
transmitting said new transaction to said first spoke if said new transaction did not originate from said first spoke or if said new transaction did originate from said first spoke but was based on conflict resolution.

51. An apparatus according to claim 50, wherein:
said step of accessing a new transaction includes accessing a log entry associated with said new transaction; and
said new transaction originated from said first spoke if said log entry identifies said spoke.

52. An apparatus according to claim 50, wherein:
said step of accessing a new transaction includes accessing a log entry associated with said new transaction; and
said new transaction originated from said first spoke if said log entry includes a commit record that identifies said spoke.

53. An apparatus according to claim 50, wherein:
said step of accessing a new transaction includes accessing a log; and
said new transaction was based on conflict resolution if said log includes a marker record indicating said conflict resolution.

54. An apparatus according to claim 50, wherein said method further comprises the step of:
transmitting said new transaction to all spokes that synchronize with said hub other than said first spoke if said new transaction originated from said first spoke and said new transaction was not based on conflict resolution.

55. An apparatus according to claim 50, wherein:
said step of transmitting is programmable such that any one of a set of different communication protocols can be used.
